(19) United States
(12) Patent Application Publication
(10) Pub. No.: US 2009/0150349 A1
(43) Pub. Date: Jun. 11, 2009

(54) DYNAMIC GEOGRAPHICAL SPATIAL SEARCH

(75) Inventors: Kevin F. Cartin, Boulder, CO (US); Berkley R. Charlton, Frederick, CO (US); Aaron Hart, Boulder, CO (US); Rebecca Mayes, Westminster, CO (US)

Correspondence Address: PITNEY BOWES INC.;35 WATERVIEW DRIVE, P.O. BOX 3000, MSC 26-22, SHELTON, CT, 06484-8000, US

(73) Assignee: Group 1 Software, Inc., Lanham, MD (US)

(21) Appl. No.: 11/954,018

(22) Filed: Dec. 11, 2007

(51) Int. Cl. G06F 17/30

(52) U.S. Cl. 707/3; 707/E17.014

(57) ABSTRACT

A method for performing a dynamic spatial search for points of interest proximal to a path of travel of a moving user. As the user moves along a path, a search is regularly conducted to provide updated information about points of interest for the user. The method includes automatically detecting a position of the user. One or more attributes of the user's movement and/or of a vicinity around the position of the user are detected. To provide the updated search information a new search region is determined based on the user's position and the one or more detected attributes. The new search region is compared to the previously determined search region to determine an overlap region that the two have in common. Search results from the overlap region are reused as part of point of interest search results for the current search region. New point of interest search results are calculated only for a portion of the new search region outside of the overlap region. Preferably, search results from the previously determined search region that are outside of the overlap are no longer needed and are discarded.

### BACKGROUND OF THE INVENTION

Spatial search technologies are known for use with navigation systems to assist users in finding points of interest in proximity to the user. For example, a traveler might wish to find a hotel in the area. A global positioning device in the system can determine where the traveler is. The search system has a database of points of interest identified by different categories, e.g. restaurants, amusements, hotels, etc., and the corresponding geographic coordinates. When the traveler indicates that he is looking for hotels in his vicinity, the system will search for hotels within the geographic vicinity and provide the results on a map, or in a list form.

### SUMMARY OF THE INVENTION

The present invention provides an improvement over existing spatial search technologies. The improved method allows for a dynamic spatial search for points of interest proximal to a path of travel of a moving user. As the user moves along a path, a search is regularly conducted to provide updated information about points of interest for the user along the user's path and projected path. The method automatically detects a position of the user. In addition to the user's location, the method provides for detecting one or more attributes of the user's movement and/or of a vicinity around the user. An example of a movement attribute can be the user's speed. An example of an attribute of the vicinity is a density of points of interest in the area. To provide the updated search information, a new search region is defined based on the user's position and the one or more detected attributes.

The new search region is compared to the previously determined search region to determine an overlap region that the two have in common. Search results from the overlap region are reused as part of point of interest search results for the current search region. New point of interest search results are calculated only for a portion of the new search region outside of the overlap region. Preferably, search results from the previously determined search region that are outside of the overlap are no longer needed and are discarded.

In a preferred embodiment, at least one of the detected attributes includes a speed of the user's movement. The step of determining the new search region includes varying a shape of the search region based on the detected speed. The varying shape of the search region includes lengthening the search region in a direction of the user's travel when the speed increases, and shortening the search region perpendicular to the user's travel direction. In the preferred embodiment, the varying shape of the search region is substantially an oval or an ellipse.

A vicinity attribute that can affect the composition of the search region can be a density of points of interest in the area. The step of determining the new search region includes varying a shape and/or size of the search region based on the detected density.

### DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention. As shown throughout the drawings, like reference numerals designate like or corresponding parts.

FIG. 1 is a flow diagram of a preferred algorithm for dynamically updating a point of interest search for a moving user.

FIGS. 2A and 2B depict exemplary varying search regions for use in finding points of interest for a moving user.

FIGS. 3A and 3B depict alternative shapes for varying search regions for use in finding points of interest for a moving user.

FIGS. 4A and 4B depict an embodiment where search regions are varied based on a density of points of interest.

FIG. 5 depicts overlapping search regions determined at two different points in time by a moving user.

### DETAILED DESCRIPTION OF THE PRESENT INVENTION

The present invention represents a new computer implemented search method for dynamically finding points of interest for a traveling user. The computer may be a navigation system on a car, or a hand-held device, as are commonly known, that have been programmed to operate in the manner described herein.

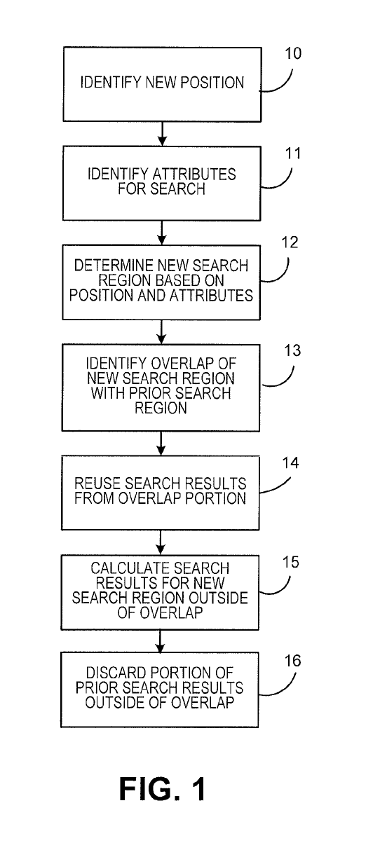

FIG. 1 depicts a preferred set of steps for providing updated dynamic point of interest (POI) search information to a moving user. These steps may be implemented in a vehicular, or hand-held device, and are useful for providing an optimized POI search based on current conditions. A first step 10 is to identify the current position of the user. Preferably, a known global positioning system (GPS) is used with the implementing device to provide the geographic coordinates of the user's location. While GPS is the preferred manner of obtaining location, any known positioning scheme is suitable. For example, it is known to locate a cell phone by using cell phone towers to triangulate upon the cell phone signal. Similarly, it is known to use a motion sensing device to track movement of an object.

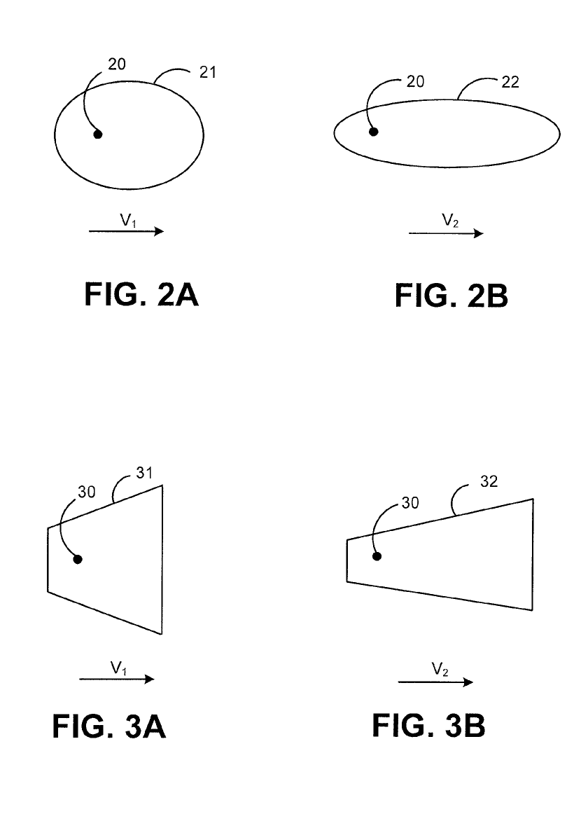

The system further identifies relevant attributes that are to be used in the context of the dynamic spatial search. (Step 11). These attributes relate to the motion of the user, or to the conditions of the surrounding area. The attributes are used to determine the nature of the point of interest search that is to be conducted. For example, as further discussed below in connection with FIGS. 2A, 2B, 3A, 3C, 4A, and 4B, the speed of the user or the density of points of interest in the vicinity will result in different sized or shaped search regions. Accordingly, the identified user position and condition attributes are used to determine a new search region in which to search for POI's. (Step 12).

As the user moves along his path of travel, the relevant search area will be continuously changing. Using the improved method, any overlap of a previously determined search region with the newly determined search region is identified. (Step 13). The search results for the overlap region of a previous search regions are then reused in connection with the new search region. (Step 14). Within the bounds of the new search region, not encompassed in the overlap region, new search results are calculated to determine new points of interest that must be added to the output results to the user. (Step 15). Portions of the search results of the prior search region that are not within the overlap region are no longer considered relevant and are not included in the output to the user, and may be discarded from memory. (Step 16).

FIGS. 2A and 2B depict exemplary different shaped search regions that are varied based on a varying velocity attribute of the user. In FIG. 2A the user 20 is traveling at a slower velocity V₁ and a search perimeter 21 is used for bounding a search region for finding POI's. The search region in FIG. 2A surrounds the user 20 with a larger portion of the region in a direction downstream the user 20. In this embodiment the shape is an oval, with a long dimension of the search region extending parallel to the direction of travel. When the user 20 is traveling at an increased speed V₂, the oval/ellipse becomes more flattened, and the search region extends farther out in front of the user 20.

FIGS. 3A and 3B depict an alternative polygonal trapezoid shape for a search region. As with FIGS. 2A and 2B described above, at higher speed V₂ the perimeter of search region 32 extends further out in front of the user 30, than when he is moving at slower speed V1. It will be understood that other variations on polygonal, curved, and geometric shapes may be applied with the same general concept of varying the shape of the search region based on the measured speed of user. In these exemplary embodiments, it can also be seen that the positioning of the search regions 21, 22, 31, 32, around the user 20, or 30, also varies as a function of the speed of the user.

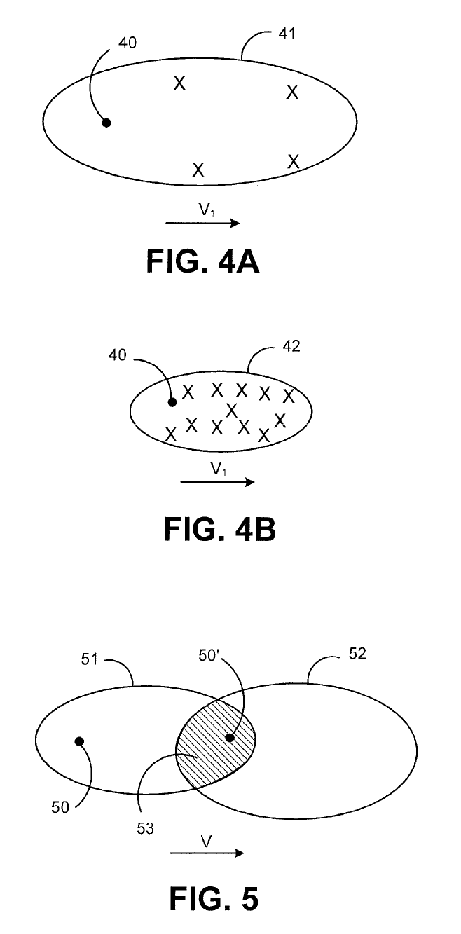

FIGS. 4A and 4B exemplify another preferred attribute upon which search region size and shape variations may be made. In these figures, the search regions are being adjusted based on the density of POI's, “X”, within them. Search regions 41, around user 40, has been made large because the user 40 is in an area that has a low density of POI's, perhaps in an urban area. For example, in FIG. 4A, the user might be traveling in a rural area that would require a broader search in order to find what the traveler is looking for. FIG. 4B depicts a situation where there is a high density of POI's. Search region 42 is relatively smaller than that in the low density scenario, because there are sufficient options for the user 40 in close vicinity. In the preferred embodiment, the size of the search region grows as the density of POI's decreases. The shape of the search region may also change. For example, the search region might extend further in a direction perpendicular to the direction of travel, when a low density situation is encountered.

FIG. 5 depicts exemplary overlapping search regions, for use as described in connection with steps 13-16 of FIG. 1. Initially, the user 50 is surrounded by a search region 51 traveling at speed V, and the respective search results are provided to the user. At a later time interval, the user has moved forward to position 50′. In calculating the search results for new search region 52, the results for the overlapping portion 53 are reused and displayed to the user. The portion of the search results outside of overlapping portion 53 are calculated for the remainder of search region 52. The search results from are 51 that are not part of the overlapping region 53 are no longer needed and may be discarded.

While the present invention has been described in connection with what is presently considered to be the most practical and preferred embodiments, it is to be understood that the invention is not limited to the disclosed embodiment, but, on the contrary, is intended to cover various modifications and equivalent arrangements included within the spirit and scope of the appended claims.

What is claimed is:

1. Method for performing a dynamic special search for points of interest proximal to a path of travel of a moving user, the method comprising:
detecting a position of the user;
detecting one or more attributes of the user's movement or of a vicinity around the position of the user;
determining a new search region based on the user's position and the one or more detected attributes, the new search region having a variable shape or size or both;
identifying an overlap region on the new search region with a previously determined search region;
reusing search results from the overlap region of the previously determined search region as part of point of interest search results for the new search region; and
calculating new point of interest search results only for a portion of the new search region outside of the overlap region.

2. The method of claim 1 further comprising discarding search results from a portion of the previously determined search region outside of the overlap region.

3. The method of claim 1 wherein at least one of the detected attributes includes a speed of the user's movement, and step of determining the new search region includes varying a shape of the search region based on the detected speed.

4. The method of claim 3 wherein the step of varying the shape of the search region includes lengthening the search region in a direction of the user's travel direction when the speed increases.

5. The method of claim 4 wherein the step of varying the shape of the search region includes shortening the search region in a direction perpendicular to the user's travel direction when the speed increases.

6. The method of claim 5 wherein the varying shape of the search region is substantially an oval or an ellipse.

7. The method of claim 1 wherein at least one of the detected attributes is a density of points of interest in the vicinity, and the step of determining the new search region includes varying a shape and/or size of the search region based on the detected density.

8. The method of claim 7 wherein the step of varying the shape and/or size of the search region includes expanding the size when there is a lower density and shrinking the size when there is a higher density.

9. The method of claim 7 wherein at least one of the detected attributes includes a speed of the user's movement, and step of determining the new search region includes varying a shape of the search region based on the detected speed.

10. The method of claim 9 wherein the step of varying the shape of the search region includes lengthening the search region in a direction of the user's travel direction when the speed increases.

11. The method of claim 10 wherein the step of varying the shape of the search region includes shortening the search region in a direction perpendicular to the user's travel direction when the speed increases.

12. The method of claim 11 wherein the varying shape of the search region is substantially an oval or an ellipse.
